(19) United States
(12) Patent Application Publication
(10) Pub. No.: US 2021/0136274 A1
(43) Pub. Date: May 6, 2021

(54) SYSTEMS AND METHODS FOR PERFORMING HIGH DYNAMIC RANGE IMAGING WITH PARTIAL TRANSFER GATE PULSING AND DIGITAL ACCUMULATION

(71) Applicant: SEMICONDUCTOR COMPONENTS INDUSTRIES, LLC, Phoenix, AZ (US)

(72) Inventor: Roger PANICACCI, Los Gatos, CA (US)

(73) Assignee: SEMICONDUCTOR COMPONENTS INDUSTRIES, LLC, Phoenix, AZ (US)

(21) Appl. No.: 16/672,256

(22) Filed: Nov. 1, 2019

(51) Int. Cl. H04N 5/235; H04N 5/232

(52) U.S. Cl. CPC H04N 5/2355; H04N 5/232411; H04N 5/23229

(57) ABSTRACT

An image sensor system may include an array of image sensor pixels. A portion of the image sensor array that includes high dynamic range (HDR) content may be oversampled at a higher rate than the rest of the array to generate multiple sub-frames. When reading out the multiple sub-frames, the charge transfer gate pulse may only be partially asserted so that only a part of the full well charge is drained. Partially asserting the charge transfer gate pulse allows drainage of the high light signals without perturbing the low light signals. The last sub-frame should be read out by fully asserting the charge transfer gate pulse to ensure than the entire well charge is drained. Data collected from the multiple sub-frames may be accumulated using digital accumulation circuitry. The rest of the array can be read out at the nominal frame rate.

### BACKGROUND

This relates generally to imaging devices, and more particularly, to imaging devices having high dynamic range imaging pixels.

Image sensors are commonly used in electronic devices such as cellular telephones, cameras, and computers to capture images. In a typical arrangement, an image sensor includes an array of image pixels arranged in pixel rows and pixel columns. Circuitry may be coupled to each pixel column for reading out image signals from the image pixels.

Some conventional image sensors may offer high dynamic range (HDR) imaging capabilities. These image sensors typically implement some charge overflow scheme to separate the high light and low light signal readout. Such overflow schemes prevent pixels from sharing the same readout circuitry since a single floating diffusion region would not be able to differentiate between the overflow charge generated from two or more shared pixels. Artifact free HDR pixels oftentimes require additional circuit components to enable charge accumulation in the pixel, which limit scaling HDR to smaller pixel sizes. Many HDR applications, however, need increased resolutions without changing the optical format, which can be achieved only by scaling the pixel to smaller sizes.

It is within this context that the embodiments herein arise.

### BRIEF DESCRIPTION OF THE DRAWINGS

FIG. 1 is a diagram of an illustrative electronic device having an image sensor and processing circuitry for capturing images using an array of image pixels in accordance with some embodiments.

FIG. 2 is a diagram of an illustrated stacked imaging system in accordance with an embodiment.

FIG. 3 is a diagram of an illustrative image sensor array coupled to digital processing circuits and analog processing circuits in accordance with an embodiment.

FIG. 4A is a diagram showing how an image pixel may be accessed using region of interest (ROI) switching circuitry in accordance with an embodiment.

FIG. 4B is a diagram of an illustrative 8×8 pixel cluster in accordance with an embodiment.

FIG. 4C is a diagram of an illustrative ROI unit cell that includes four pixel clusters in accordance with an embodiment.

FIG. 4D is a diagram of another ROI cell formed at the bottom of each pixel column in accordance with an embodiment.

FIG. 5 is a diagram showing how a high dynamic range (HDR) sub-region within an ROI tile may be read out and digitally accumulated in accordance with an embodiment.

FIG. 6 is a flow chart of illustrative steps for using the circuitry shown in FIG. 5 to obtain multiple sub-frames for the HDR sub-region in accordance with an embodiment.

FIG. 7A is a diagram illustrating how a reduced gate transfer pulse will not affect low light charge in accordance with an embodiment.

FIG. 7B is a diagram illustrating how a reduced gate transfer pulse will drain at least a portion of the high light charge in accordance with an embodiment.

FIGS. 8A and 8B are timing diagrams illustrating the sub-frame read out of an HDR window in accordance with an embodiment.

### DETAILED DESCRIPTION

Electronic devices such as digital cameras, computers, cellular telephones, and other electronic devices may include image sensors that gather incoming light to capture an image. The image sensors may include arrays of image pixels. The pixels in the image sensors may include photosensitive elements such as photodiodes that convert the incoming light into image signals. Image sensors may have any number of pixels (e.g., hundreds or thousands or more). A typical image sensor may, for example, have hundreds of thousands or millions of pixels (e.g., megapixels). Image sensors may include control circuitry such as circuitry for operating the image pixels and readout circuitry for reading out image signals corresponding to the electric charge generated by the photosensitive elements.

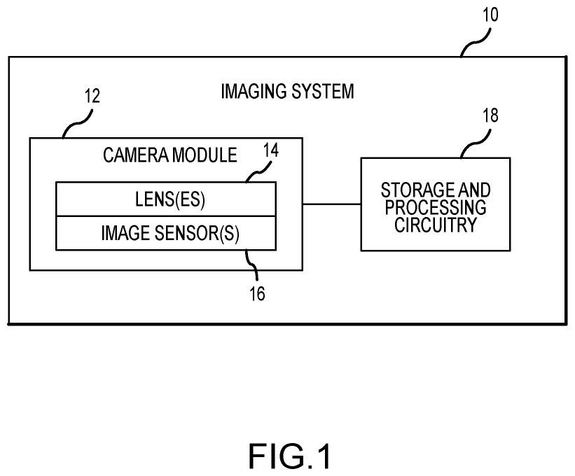

FIG. 1 is a diagram of an illustrative imaging system such as an electronic device that uses an image sensor to capture images. Electronic device 10 of FIG. 1 may be a portable electronic device such as a camera, a cellular telephone, a tablet computer, a webcam, a video camera, a video surveillance system, an automotive imaging system, a video gaming system with imaging capabilities, or any other desired imaging system or device that captures digital image data. Camera module 12 may be used to convert incoming light into digital image data. Camera module 12 may include one or more lenses 14 and one or more corresponding image sensors 16. Lenses 14 may include fixed and/or adjustable lenses and may include microlenses formed on an imaging surface of image sensor 16. During image capture operations, light from a scene may be focused onto image sensor 16 by lenses 14. Image sensor 16 may include circuitry for converting analog pixel data into corresponding digital image data to be provided to storage and processing circuitry 18. If desired, camera module 12 may be provided with an array of lenses 14 and an array of corresponding image sensors 16.

Storage and processing circuitry 18 may include one or more integrated circuits (e.g., image processing circuits, microprocessors, storage devices such as random-access memory and non-volatile memory, etc.) and may be implemented using components that are separate from camera module 12 and/or that form part of camera module 12 (e.g., circuits that form part of an integrated circuit that includes image sensors 16 or an integrated circuit within module 12 that is associated with image sensors 16). Image data that has been captured by camera module 12 may be processed and stored using processing circuitry 18 (e.g., using an image processing engine on processing circuitry 18, using an imaging mode selection engine on processing circuitry 18, etc.). Processed image data may, if desired, be provided to external equipment (e.g., a computer, external display, or other device) using wired and/or wireless communications paths coupled to processing circuitry 18.

In accordance with an embodiment, a selected sub-region that has been identified to include high dynamic range (HDR) content may be read out multiple times to obtain corresponding sub-frames during a frame period using a reduced transfer gate high voltage. The signal read out from each sub-frame may be digitally accumulated. The last sub-frame in the frame period may be read out using a fully asserted transfer gate voltage to ensure complete charge transfer. Operated in this way, low light signal can be read out at least during the last sub-frame while capturing the high light features via digital accumulation with minimal impact to the signal-to-noise ratio (SNR).

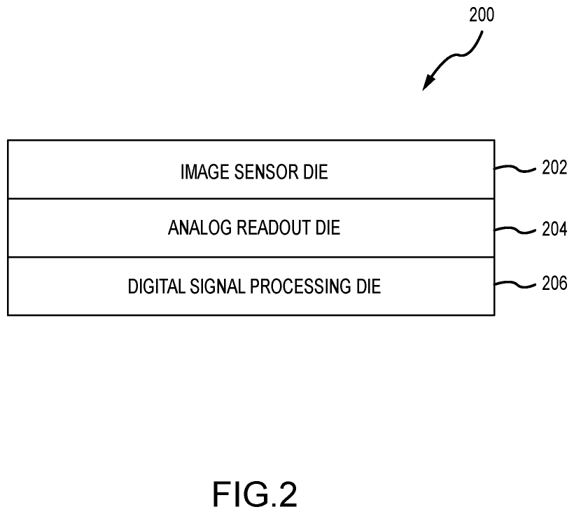

Die stacking may be leveraged to allow the pixel array to connect to corresponding region of interest (ROI) processors to enable efficient analog readout (e.g., to read out selected portions of the array that may include HDR content and that are not being read out through the normal digital signal processing path). FIG. 2 is a diagram of an illustrated stacked imaging system 200. As shown in FIG. 2, system 200 may include an image sensor die 202 as the top die, a digital signal processor die 206 as the bottom die, and an analog readout die 204 that is stacked vertically between top die 202 and bottom die 206. The array of image sensor pixels may reside within the top image sensor die 202; the normal digital readout circuits may reside within the bottom die 206; and the analog readout circuitry may be formed within the middle die 204. If desired, other ways of stacking the various imager dies may also be used.

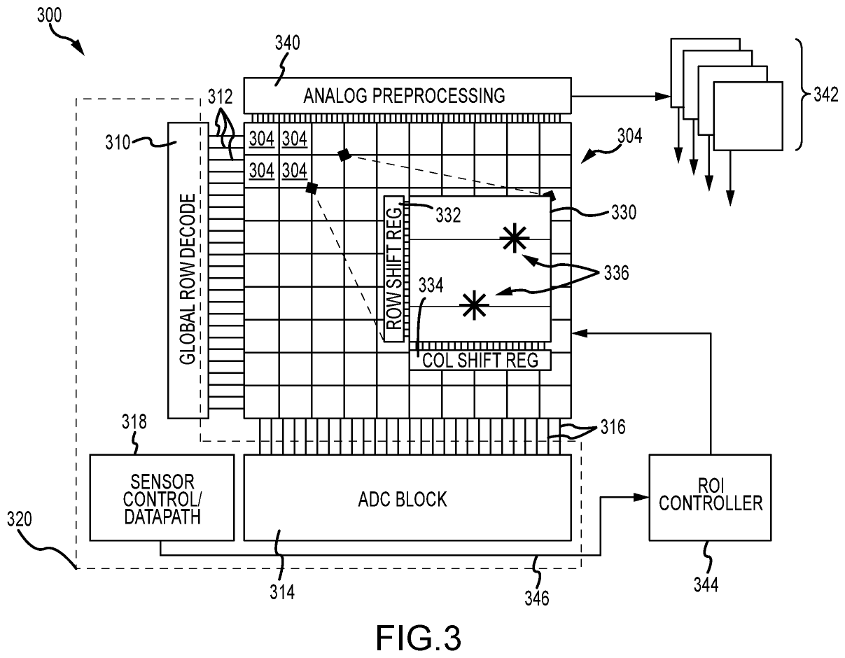

FIG. 3 is a diagram of an illustrative image sensor array 302 coupled to digital processing circuits and analog processing circuits. The digital signal processing circuits are delineated by dotted box 320, which include a global row decoder 310 configured to drive all the pixel rows within array 302 via row control lines 312, an analog-to-digital converter (ADC) block 314 configured to receive pixels values via each pixel column through the normal readout paths 316, and a sensor controller 318. These digital signal processing circuits 320 may reside within the bottom die 206 (see FIG. 2).

The image pixel array 302 may be formed on the top image sensor die 202. Pixel array 302 may be organized into groups sometimes referred to as “tiles” 304. Each tile 304 may, for example, include 256×256 image sensor pixels. This tile size is merely illustrative. In general, each tile 304 may have a square shape, a rectangular shape, or an irregular shape of any suitable dimension (i.e., tile 304 may include any suitable number of pixels).

Each tile 304 may correspond to a respective “region of interest” (ROI) that has been identified to potentially include HDR content. A separate ROI processor 330 may be formed in the analog die 204 below each tile 304. Each ROI processor 330 may include a row shifter register 332, a column shift register 336, and row control and switch matrix circuitry for selectively combining the values from multiple neighboring pixels, as represented by converging lines 336. Signals read out from each ROI processor 330 may be fed to analog processing and multiplexing circuit 340 and provided to circuits 342. Circuits 342 may include analog filters, comparators, high-speed ADC arrays, etc. Sensor control 318 may send signals to ROI controller 344, which controls how the pixels are read out via the ROI processors 330. For example, ROI controller 344 may optionally control pixel reset, pixel charge transfer, pixel row select, pixel dual conversion gain mode, a global readout path enable signal, a local readout path enable signal, switches for determining analog readout direction, ROI shutter control, etc. Circuits 330, 340, 342, and 344 may all be formed within the analog die 204.

An imaging system configured in this way may support content aware sensing. The analog readout path supports rapid scanning for HDR content detection, shape/feature detection, non-destructive intensity thresholding, temporal events, and may also use on-board vision smart components to process shapes. The high-speed ROI readout path can also allow for digital accumulation and burst readout without impact to the normal frame readout. If desired, this content aware sensor architecture may be configured to read out different regions at varying resolutions (spatial, temporal, bit depth) based on the importance of that part of the scene. Smart sensors are used to monitor activity/events in regions of the image that are not read out at full resolution to determine when to wake up that region for higher resolution processing.

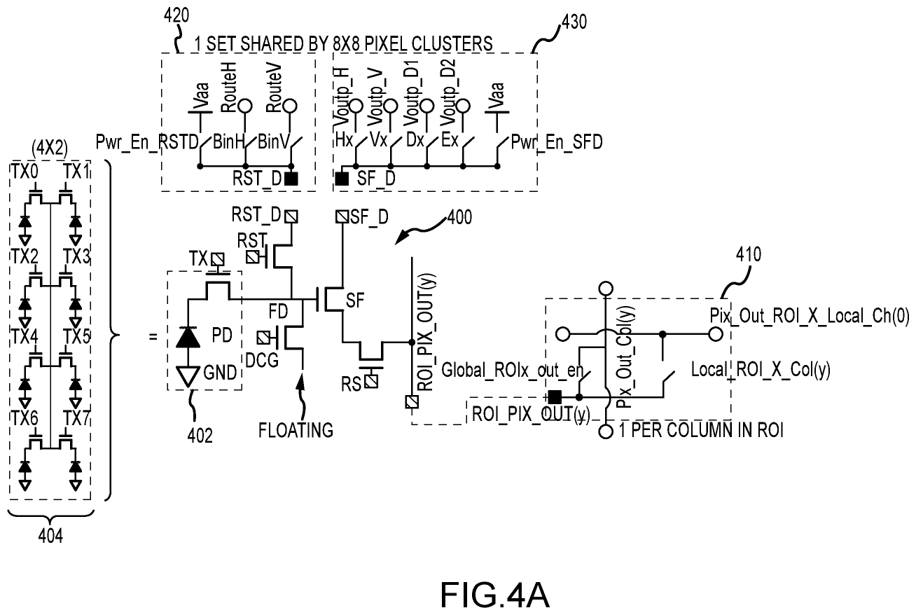

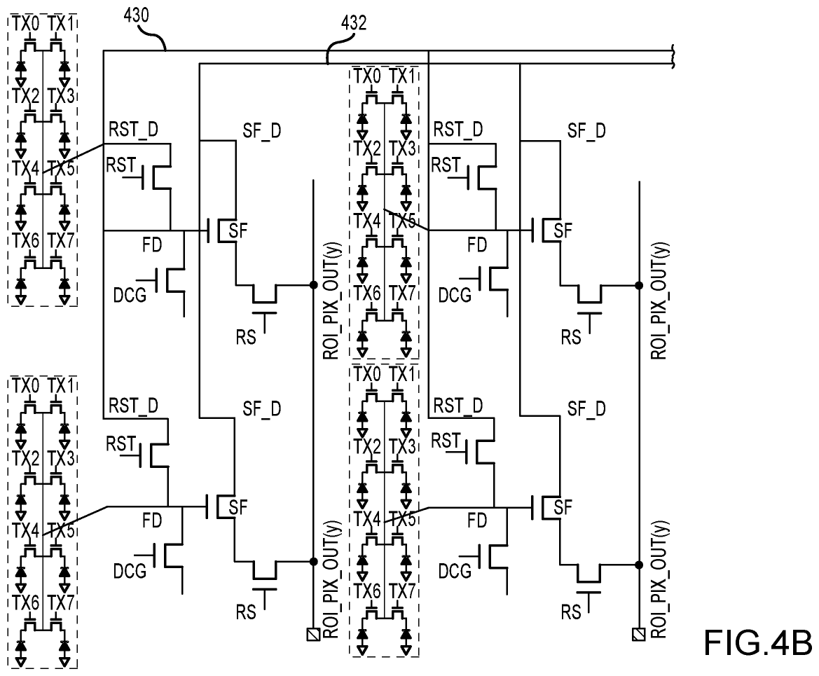

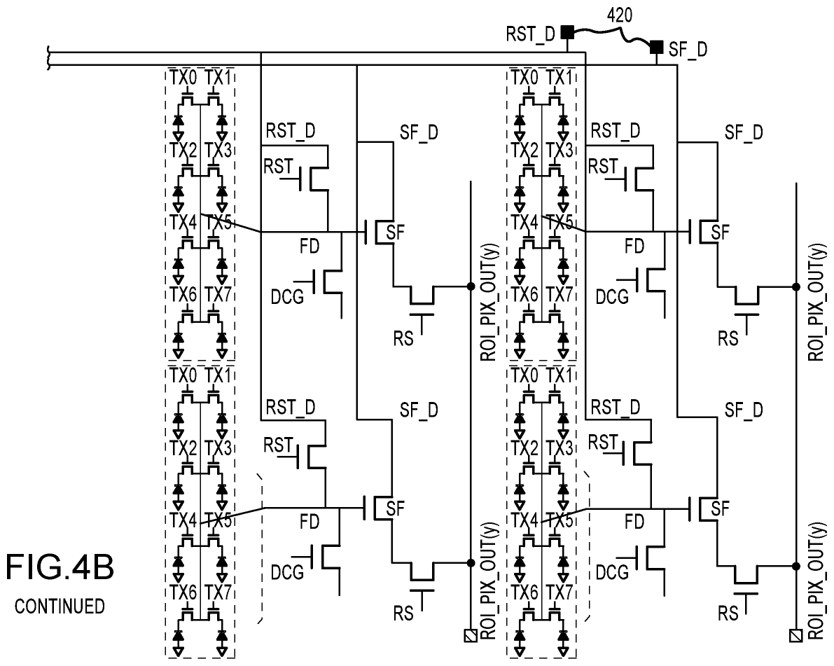

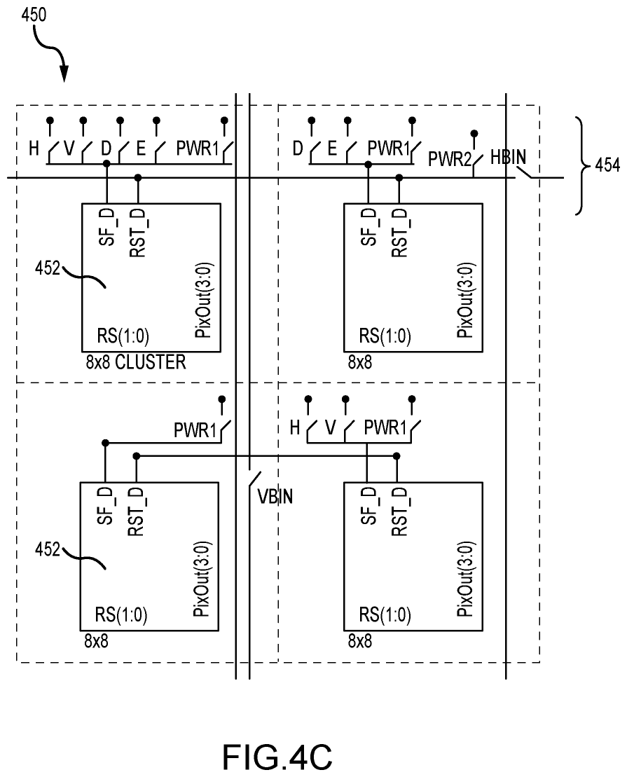

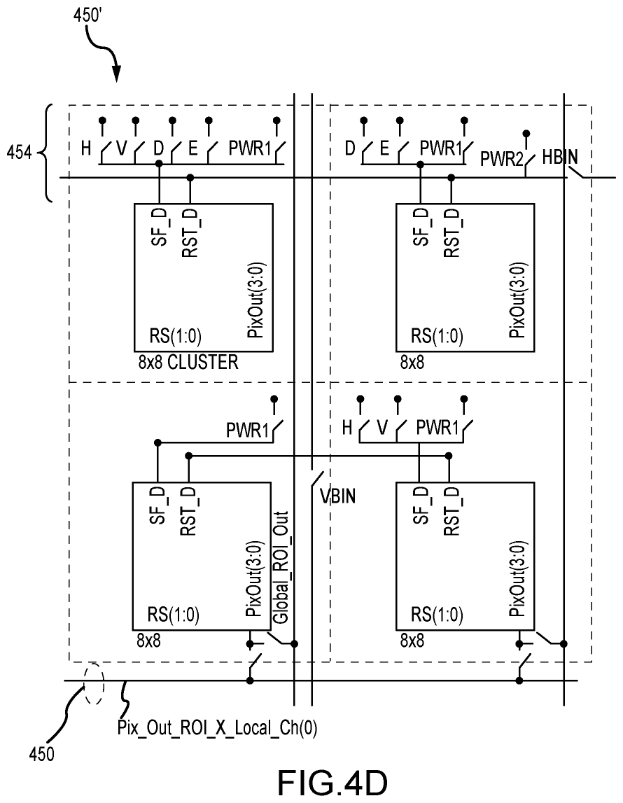

FIG. 4A is a diagram showing how an image pixel may be accessed using region of interest (ROI) switching circuitry in accordance with an embodiment. As shown in FIG. 4A, an image sensor pixel such as image pixel 400 may include a photodiode PD coupled to a floating diffusion node FD via a charge transfer transistor (i.e., the transistor with a gate terminal controlled by charge transfer control signal TX), a reset transistor coupled between the FD node and a reset drain node RST_D, a dual conversion gain (DCG) transistor having a first terminal connected to the FD node and a second terminal that is electrically floating, a source follower transistor with a drain node SF_D, a gate terminal connected to the FD node, and a source node coupled to the ROI pixel output line via a corresponding row select transistor. Portion 402 of pixel 400 may alternatively include multiple photodiodes that share a single floating diffusion node. As an example, configuration 404 illustrates a configuration where 4 rows of pixel pairs (e.g., each pixel pair having a first pixel in the even column and a second pixel in the odd column) coupled to the FD region. This type of pixel sharing may sometimes be referred to as a “4×2” pixel sharing scheme.

In one suitable arrangement, each reset drain node RST_D within an 8×8 pixel cluster may be coupled to a group of reset drain switches 420. This is merely illustrative. In general, a pixel cluster that share switches 420 may have any suitable size and dimension. Switches 420 may include a reset drain power enable switch that selectively connects RST_D to positive power supply voltage Vaa, a horizontal binning switch that selectively connects RST_D to a horizontal routing line RouteH, a vertical binning switch that selectively connects RST_D to a vertical routing line RouteV, etc. Switch network 420 configured in this way enables connection to the power supply, binning charge from other pixels, and focal plane charge processing.

Each source follower drain node SF_D within the pixel cluster may also be coupled to a group of SF drain switches 430. Switch network 430 may include a SF drain power enable switch Pwr_En_SFD that selectively connects SF_D to power supply voltage Vaa, switch Hx that selectively connects SF_D to a horizontal line Voutp_H, switch Vx that selectively connects SF_D to a vertical line Voutp_V, switch Dx that selectively connects SF_D to a first diagonal line Voutp_D1, switch Ex that selectively connects SF_D to a second diagonal line Voutp_D2, etc. Switches 430 configured in this way enables the steering of current from multiple pixel source followers to allow for summing/differencing to detect shapes and edges and connection to a variable power supply.

Each pixel output line ROI_PIX_OUT(y) within the pixel cluster may also be coupled to a group of pixel output switches 410. Switch network 410 may include a first switch Global_ROIx_out_en for selectively connecting the pixel output line to a global column line Pix_Out_Col(y) and a second switch Local_ROI_X_Col(y) for selectively connecting the pixel output line to a local bus Pix_Out_ROI_X_Ch(0) that can be shared between different columns. Configured in this way, switches 410 connect each pixel output from the ROI to one of the global pixel output bus for readout, to a high speed local readout signal chain for digital accumulation, to a serial readout bus to form the circuit used to detect shapes/edges, to a variable power supply, etc. Switches 410, 420, and 430 may optionally be formed as part of the analog readout die 204 (see FIG. 2).

FIG. 4B is a diagram of an illustrative 8×8 pixel cluster. A shown in FIG. 4B, the RST_D nodes of each image pixel group in the cluster are interconnected via a reset drain coupling path 430, whereas the SF_D nodes of each image pixel group in the cluster are interconnected via a source follower drain coupling path 432.

FIG. 4C is a diagram of an illustrative ROI unit cell 450 that includes four pixel clusters 452. Switches 454 may be formed on the stacked intermediate RO controller die. FIG. 4D is a diagram of another ROI cell 450′ that can be formed at the bottom of each pixel column. As shown in FIG. 4D, ROI 450′ may be configured to route the pixel output from the ROI to a global pixel output bus or to a common local output line Pix_Out_ROI_X_Local_Ch(0). If desired, there may be one or more local output buses per ROI (e.g., 4 buses per tile).

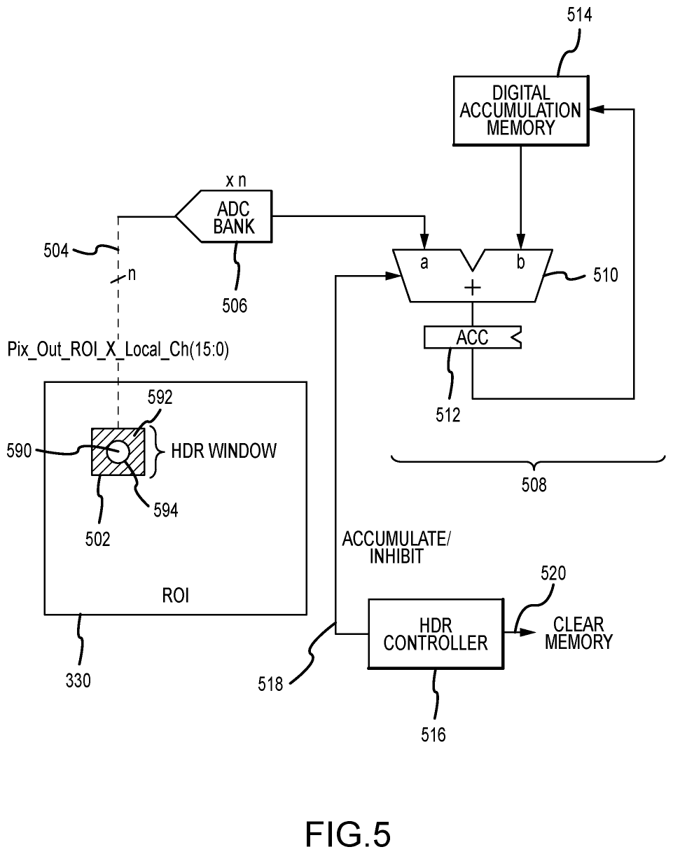

FIG. 5 is a diagram showing how a high dynamic range (HDR) sub-region 502 within an ROI tile 330 may be read out and digitally accumulated in accordance with an embodiment. As shown in FIG. 5, ROI tile 330 may include a smaller sub-region 502 that includes HDR content. Sub-region 502 (sometimes referred to as an “HDR window”) may have a high light portion 590, a low light portion 592, and an edge 594 that separates the high light and low light portions or defines the high light portion 590. As an example, the ROI tile 330 may have 256×256 pixels while the sub-region 502 includes a 16×16 window of pixels. As another example, the ROI tile may have 576×576 pixels while the HDR region 502 is a 64×64 pixel window. These arrangements are merely illustrative. In general, the ROI tile may include any suitable number of pixels, and window 502 may be any desired subset of the larger ROI.

The image pixels within window 502 may be accessed or read out using the ROI switching circuitry described in connection with FIGS. 3 and 4A-4D. For instance, n pixel columns may be read out in parallel using the local Pix_Out_ROIx_Local_Ch(15:0) readout paths 504, where n is equal to 16 in this example. Analog-to-digital converter (ADC) bank 506, which may be formed as part of the middle analog die or bottom digital die, may include n ADC circuits for converting the signals read out from the n pixel columns into their digital equivalent. One method of readout is to sample only the high light signal levels captured in the photodiode and accumulate multiple samples digitally using digital accumulation circuitry 508.

As illustrated in FIG. 5, digital accumulation circuitry 508 may include an adder circuit 510, an accumulation register 512, and associated memory 514. Memory 514 (sometimes referred to as digital accumulation memory) may be implemented as volatile memory (e.g., static random-access memory or SRAM) or as non-volatile memory (e.g., flash-based memory). Adder circuit 510 may have a first (a) input terminal configured to receive converted digital signals from the ADC bank 506, a second (b) input terminal configured to receive prior accumulated values from digital accumulation memory 514, and an output on which a corresponding sum signal is generated. The sum signal may optionally be latched using accumulation registers 512 prior to being stored within digital accumulation memory 514. Digital accumulation circuitry 508 may be formed as part of the middle analog die or bottom digital die. A control circuit such as HDR controller 516, which may be formed on the same die as digital accumulation circuitry 508, may generate a control signal for selectively enabling or inhibit signal accumulation (see control path 518) and may also generate a clear signal at output 520 for resetting the digital accumulation memory 514 to zero at the beginning of a frame.

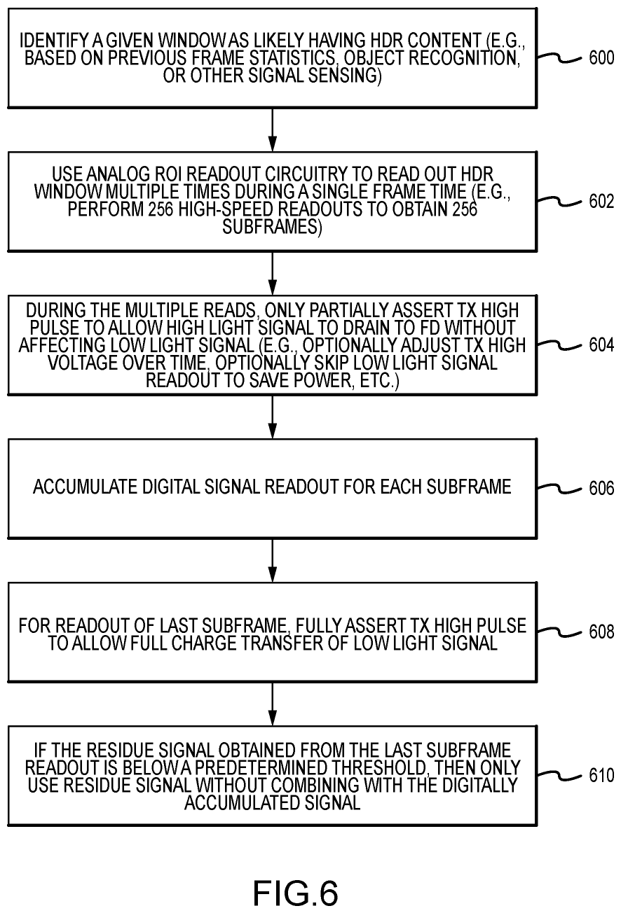

FIG. 6 is a flow chart of illustrative steps for using the circuitry shown in FIG. 5 to obtain multiple sub-frames for the HDR window. At step 600, control circuitry such as HDR controller 516 may be configured to identify a given window or sub-region 502 that is likely to include HDR image content (i.e., a portion of the frame having both high light and low light signals). The determination of whether a given sub-region 502 has HDR content may be based on previous frame statistics (e.g., whether that window in the previous frame exhibits HDR content), object recognition (e.g., by identifying shapes or objects with a high probability of requiring high dynamic range), or other signal sensing operations (e.g., via non-destructive sensing of the FD node).

At step 602, the analog readout circuitry of the middle die (e.g., the RO switching circuitry described in connection with at least FIGS. 3, 4A, and 4C may be used to read out signals from the HDR window 502 multiple times during a single frame period. Assuming the ROI readout circuitry and the digital accumulation circuitry are all formed in the middle die, this ROI/HDR readout scheme minimizes circuit loading while allowing more efficient high speed sub-frame readout by bypassing the normal digital readout path to the bottom digital die.

For instance, during a single frame time, the HDR window may be read out 256 times to obtain 256 corresponding sub-frames. Each of the 256 sub-frames should have the same fixed exposure period. The HDR sub-region needs to be sampled at a rate 256× faster than the longest integration time set by the frame rate. Assuming the nominal frame rate is 60 frames per second (fps), the high-speed readout path with a 256× sub-frame digital accumulation would require a readout channel that supports 15360 fps (i.e., 256×60). Extreme frame rates such as this are possible for ROIs with very few columns and very few rows around the HDR content. Compared to a single exposure, accumulating signals from 256 sub-frames can help increase the dynamic range by approximately 48 dB while not decreasing the signal-to-noise ratio (SNR) since the high-speed readout noise will still be less than the shot noise of the signal generated at the photodiode (i.e., the read noise floor increases from the digital accumulation by a factor of the oversampling ratio, but for high light, the overall noise is still dominated by shot noise). This is, however, merely illustrative. If desired, each HDR window may be read out (during a single frame) at least 16 times, at least 32 times, at least 64 times, at least 128 times, 128-256 times, 256-512 times, 512-1024 times, or thousands of times to generate the corresponding number of sub-frames. Moreover, the exposure period for each sub-frame need not be equal and can be dynamically adjusted. If desired, the total number of sub-frames collected can be adjusted or reduced if the flicker artifacts are negligible or if the HDR controller can simply extrapolate or otherwise accurately estimate the final readout value.

As another example, assuming a 64×64 HDR window having HDR content that needs to be sampled at a rate of 256× faster than the longest exposure time and that needs to operate with a nominal frame rate of 30 fps, the 64×64 window needs to be oversampled at a rate of 7680 fps. The individual pixel readout rate will be equal to 64×64×7680=31.6 Ms/sec. Thus, a 16 channel readout path needs to run at 2 Ms/sec to achieve this HDR goal. The readout performance can be further improved by reducing the capacitance of the readout path or by using high pixel/ADC biasing schemes to increase speed. If, however, the speed of the channel readout path is limited, sparse readout may be required. For example, pixels can be skipped if they do not contain HDR content within the window and/or the readout can be kept utilized on another pixel within the row, which is an inherent advantage of serial readout.

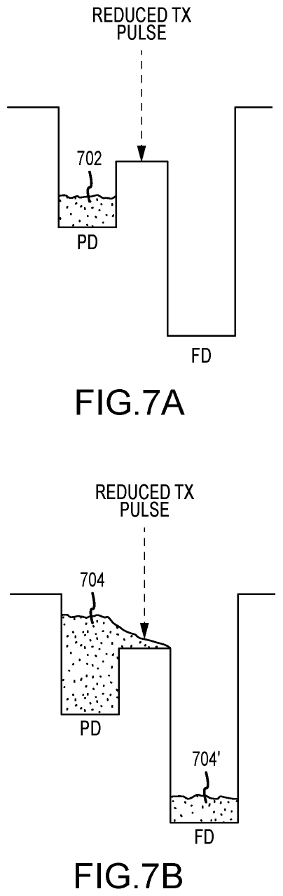

During the multiple high-speed readout of the sub-frames, the charge transfer signal TX pulse may only be partially asserted to allow the high light signal to drain to the floating diffusion node FD without affecting the low light signal (see, e.g., FIGS. 7A and 7B). As shown in FIG. 7A, charge 702 generated in photodiode region PD due to low light should not be enough to spill over to the FD region if the TX pulse height is reduced. As shown in FIG. 7B, however, charge 704 generated in photodiode PD due to high light should be able to spill over to the FD region even with the reduced TX pulse height (see spill-over charge 704′ in the FD region). Thus, there should be a partial transfer of charge for high light signals only.

Consider a scenario in which the nominal high voltage for charge transfer signal is 3.6 V. In this scenario, the reduced TX high voltage may be equal to 3.0 V. Partially reducing the TX high voltage from 3.6 V to 3.0 V may be enough to allow up to one-half (½) of the full photodiode well to remain when the TX gate is pulsed. This is, however, merely illustrative. In general, the TX pulse height may be adjusted to any intermediate voltage level to allow only ¼ of the full well to remain, only ⅓ of the full well to remain, only ⅕ of the full well to remain, only ⅔ of the full well to remain, only ¾ of the full well to remain, only ⅘ of the full well to remain, etc. If desired, the TX pulse high voltage may optionally be adjusted over time during each frame period, the readout and digital accumulation for low light signals may be skipped to save ADC power and improve readout speed since the readout of low light signals should be zero anyways, as illustrated in FIG. 7A (e.g., columns known to contain only low light signal can be skipped for digital accumulation to improve readout speed while only relying on the full charge transfer obtained from the last sub-frame, as described below). The signals read out for each sub-frame may be converted to digital signals using ADC bank 506 (FIG. 5).

At step 606, the digital signals read out from each sub-frame may be accumulated with previously accumulate signal values at the digital accumulation circuitry 508. When storage space on the digital accumulation memory is no longer available, the image sensor can optionally switch to other HDR modes like multiple exposure or spatial interleaving. When reading out the final sub-frame, however, the TX gate pulse should be fully asserted to allow all the charge in the PD well to drain into the FD region (step 608). Operated in this way, any remaining charge will be transferred to the FD node and read out at the last sub-frame.

The signal level read out from the last sub-frame by raising the TX high voltage to the nominal high level may sometimes be referred to as the “residue” signal. If the residue signal level obtained from the final sub-frame is below a predetermined threshold (e.g., if the charge read out is less than half of the full well charge capacity, assuming the partial TX pulse is configured to drain half of the full well charge), then low light charge is assumed and then only the residue signal should be used for the final readout without combining with any previous digitally accumulated signal since the previous spill-over charge is presumed to be in error (step 608).

If, however, the residue signal level is at or exceeds the predetermined threshold (e.g., if the charge read out is equal to half the full well PD capacity, assuming the partial TX pulse is configured to drain half of the full well charge), then high light charge is assumed, so the residue signal should be combined with the previously accumulated signal to generate the final signal. Operated as such, all photo-generated charge is counted and no signal is lost, unless integration time is stopped short of the total available time at the end of integration. By asserting the TX pulse fully, this readout scheme is also insensitive to TX barrier variation, because all charge is collected via the residue readout.

The charge readout scheme described in connection with FIG. 6 may be suitable for any pixel structure, with or without sharing, can scale to small pixel sizes to satisfy high resolution HDR applications with stringent optical format constraints (which can help keep sensor cost low), and is capable of achieving the desired low light SNR while capturing the high light features with minimal impact to high light SNR. Since the photodiode is not turned off between the readout of successive sub-frames, this readout scheme also avoids flicker from light-emitting diodes (LEDs) or objects illuminated by LEDs.

In one suitable arrangement, only selected HDR windows may be read out in this way while portions of the frame without HDR content may be read out without having to obtain multiple sub-frames to minimize power consumption and maintain high readout speed. If desired, the HDR window may be selected via the local ROI readout switches or via random pixel access using at least two TX gates for selecting pixels within a HDR sub-region (e.g., one controlled via row signals and one controlled via column signals). If desired, the HDR readout may only be performed on just the edge regions of the expected HDR region (see edge 594 between very bright and very dark regions in FIG. 5). On the other hand, areas of the image that include mostly dark signal levels may be read out using a long integration time with a single pixel readout. In contrast, areas of the image that include mostly bright signal levels may be read out using a relatively shorter integration time with a single pixel readout. Only areas determined to include HDR content with very bright signal levels and dark signal levels may require the multiple high-speed (oversampled) readout using reduced TX pulses and digital accumulation.

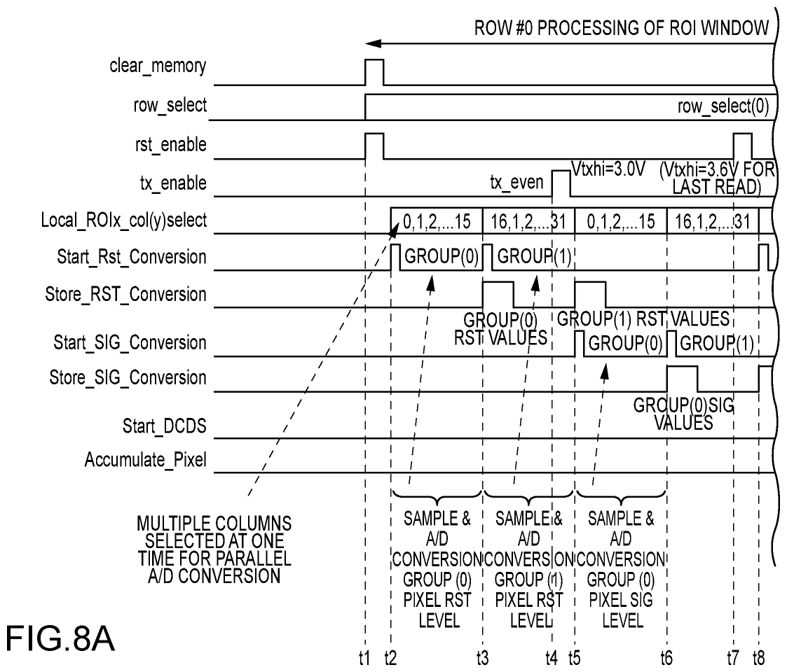

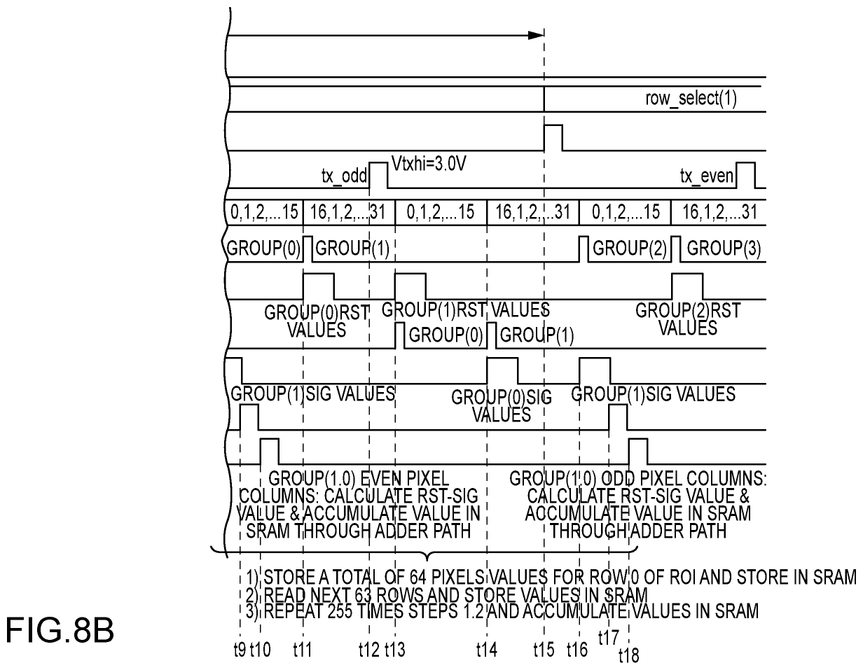

FIGS. 8A and 8B are timing diagrams showing the behavior of relevant signals during the readout of an HDR sub-frame with 64×64 pixels (as an example). At time t1 (see starting on FIG. 8A), the clear memory signal may be pulsed high to reset the digital accumulation memory to zero, the row select signal for the first row (i.e., row 0) may be asserted to address row 0 of the image sensor, and the reset enable signal may be pulsed high to reset the corresponding floating diffusion regions. The clear memory signal should only be pulsed high once at the beginning of the frame (e.g., at the beginning of the first sub-frame and after the last of the multiple sub-frames).

At time t2, the local ROI column select signals may be configured to select column pairs 0-15 (collectively referred to as “Group(0)”), which include 16 even columns 20 and 16 odd columns for a total of 32 pixels. Only the even columns in each column pair may be selected at this time. At time t2, the reset conversion start signal is also pulsed high to sample and convert the pixel reset levels for Group(0).

At time t3, the converted pixel reset levels for Group(0) may be stored while the local ROI column select signals may be configured to select column pairs 16-31 (collectively referred to as “Group(1)”), which also include 16 even columns and 16 odd columns for a total of 32 pixels. Only the even columns in each column pair in Group(1) may be accessed at this time. At time t3, the reset conversion start signal is also pulsed high to sample and convert the pixel reset levels for Group(1).

At time t4, the charge transfer gate control signal for all the even columns may be partially asserted to drain any charge exceeding a reduced voltage barrier level. In the example of FIGS. 8A and 8B, assuming a nominal TX high voltage level of 3.6 V, the partially asserted TX voltage level may be 3.0 V to drain up to half of the full well charge. This is merely illustrative. If desired, the reduced TX voltage may be no more than 90% of the nominal high voltage level, no more than 80% of the nominal high voltage level, no more than 70% of the nominal high voltage level, no more than 60% of the nominal high voltage level, no more than 50% of the nominal high voltage level, or other suitable voltage level that is capable of draining at least some of high light signals without draining low light signals residing in the PD well.

At time t5, the converted pixel reset levels for Group(1) may be stored while the image signal conversion start signal is also pulsed high to sample and convert the pixel signal levels corresponding to any transferred charge for Group(0). At time t6, the converted pixel signal levels for Group(0) may be stored while the image signal conversion start signal is also pulsed high to sample and convert the pixel signal levels corresponding to any transferred charge for Group(1). At time t7, the reset enable signal may be pulsed high to again reset the FD regions.

At time t8, the converted pixel signal levels for Group(l) may be stored while the reset conversion start signal is also pulsed high to sample and convert the pixel reset levels now for the odd pixel columns in Group(0). At time t9 (see starting on FIG. 8B), a digital correlated double sampling (DCDS) start signal may be asserted to perform DCDS on the even column signals read out from time t2-t8 (e.g., to subtract the digital pixel signal levels from the digital pixel reset levels). At time t10, an accumulate pixel signal may be pulsed high to combine the resulting DCDS value with any previously accumulated value into the digital accumulation memory.

At time t11, the converted pixel reset levels for Group(0) obtained after time t8 may be stored while the reset conversion start signal is also pulsed high to sample and convert the pixel reset levels now for the odd pixel columns in Group(1).

At time t12, the charge transfer gate control signal for all the odd columns may be partially asserted to drain any charge exceeding the reduced voltage barrier level (e.g., to drain at least half of the full well charge, at least a third of the full well charge, at least a quarter of the full well charge, or other desired fraction of the full well capacity).

At time t13, the converted pixel reset levels for Group(1) may be stored while the image signal conversion start signal is also pulsed high to sample and convert the pixel signal levels corresponding to any transferred charge for Group(0). At time t14, the converted pixel signal levels for Group(0) may be stored while the image signal conversion start signal is also pulsed high to sample and convert the pixel signal levels corresponding to any transferred charge for Group(1). At time t5, the reset enable signal may be pulsed high to again reset the FD regions for the next row of pixels. At this time, the row select signal for the second row (i.e., row 1) may be asserted to start addressing row 1 of the image sensor,

At time t16, the converted pixel signal levels for Group(1) may be stored while the reset conversion start signal is also pulsed high to sample and convert the pixel reset levels now for the even pixel columns in Group(2) (i.e., the 16 even columns in row 1). At time t17, the DCDS start signal may be asserted to perform DCDS on the odd column signals read out from time t8-t16 (e.g., to subtract the digital pixel signal levels from the digital pixel reset levels). At time t18, the accumulate pixel signal may be pulsed high to combine the resulting DCDS value with any previously accumulated value into the digital accumulation memory.

The operations performed during time t1-t18 will generate and store 64 pixel values for row0 in the HDR window of interest and store/accumulate any DCDS result in the digital accumulation memory. These steps may be repeated 255 more times, 127 more times, 511 more times, 1023 more times, 63 more times, or any suitable number of times to obtain the desired number of total sub-frames needed to achieve the requisite HDR specification.

The foregoing is merely illustrative of the principles of this invention and various modifications can be made by those skilled in the art. The foregoing embodiments may be implemented individually or in any combination.

What is claimed is:

1. Imaging circuitry, comprising:
an array of image sensor pixels, wherein:
each image sensor pixel in the array comprises a photodiode, a floating diffusion region, and a corresponding charge transfer transistor that is coupled between the photodiode and the floating diffusion region and that is controlled by a charge transfer control signal;
a window of image sensor pixels in the array having high dynamic range (HDR) content is read out by partially asserting the charge transfer control signals for the image sensor pixels within the window;
the photodiode of a first image sensor pixel in the window having a high light signal is at least partially drained by the partial assertion of the charge transfer control signals;
the photodiode of a second image sensor pixel in the window having a low light signal remains unperturbed by the partial assertion of the charge transfer control signals; and
at least some of the image sensor pixels outside the window are read out by fully asserting the charge transfer control signals for the at least some of the image sensor pixels outside the window.

2. The imaging circuitry of claim 1, wherein the window with the HDR content is oversampled to generate multiple sub-frames.

3. The imaging circuitry of claim 2, wherein data from the multiple sub-frames are combined using digital accumulation circuitry.

4. The imaging circuitry of claim 3, wherein the digital accumulation circuitry comprises:
an adder circuit having an output;
an accumulation register circuit coupled to the output of the adder circuit; and
digital accumulation memory coupled between the accumulation register circuit and the adder circuit.

5. The imaging circuitry of claim 4, further comprising:
a high dynamic range (HDR) controller that is configured to selectively enable and inhibit the digital accumulation circuitry.

6. The imaging circuitry of claim 5, wherein the HDR controller is further configured to clear the digital accumulation memory.

7. The imaging circuitry of claim 2, wherein the last of the multiple sub-frames is read out by fully asserting the charge transfer control signals for the image sensor pixels within the window.

8. The imaging circuitry of claim 2, wherein the at least some of the image sensor pixels outside the window are not oversampled.

9. The imaging circuitry of claim 2, wherein the number of sub-frames generated is at least equal to or greater than 64 in a given frame period.

10. The imaging circuitry of claim 1, wherein partially asserting the charge transfer control signals comprises draining up to half of the full well capacity of the corresponding photodiodes within the window.

11. A method of operating imaging circuitry having an array of pixels, the method comprising:
identifying a given sub-region in the array as having high dynamic range (HDR) content with a high light signal and a low light signal;
reading out from the given sub-region multiple times during a single frame time to generate a plurality of sub-frames; and
while generating the plurality of sub-frames, partially asserting a charge transfer gate pulse to allow the high light signal to drain to a corresponding floating diffusion node in the pixels of the given sub-region without affecting the low light signal.

12. The method of claim 11, further comprising generating at least 128 sub-frames during the signal frame time.

13. The method of claim 11, further comprising adjusting the voltage level of the charge gate pulse over time.

14. The method of claim 11, further comprising skipping the readout of the low light signal to save power.

15. The method of claim 11, further comprising digitally accumulating data from the plurality of sub-frames.

16. The method of claim 11, wherein the last sub-frame of each frame time is read out by fully asserting the charge transfer gate pulse to allow full charge transfer to the corresponding floating diffusion node.

17. The method of claim 16, further comprising:
determining whether a residue signal read out from the last sub-frame exceeds a predetermined threshold; and
in response to determining that the signal read out from the last sub-frame is less than the predetermined threshold, using only the residue signal as the final output value without combining with prior accumulated signals.

18. The method of claim 11, further comprising:
using previous frame statistics or object recognition data to identify the given sub-region as having HDR content.

19. An imaging system, comprising:
an array of pixels, wherein first pixels in the array have high light signals, and wherein second pixels in the array have low light signals;
readout circuitry configured to read out only the high light signals by pulsing a charge transfer gate voltage that is only partially high without reading out the low light signals; and
digital accumulation circuitry configured to accumulate signals read out from only the high light signals.

20. The imaging system of claim 19, wherein the array of pixels is formed in a first die, and wherein the readout circuitry and the digital accumulation circuitry are formed in a second die below the first die.

21. The imaging system of claim 19, wherein the array of pixels is formed in a top die, wherein the digital accumulation circuitry is formed in a bottom die below the top die, and wherein the readout circuitry is formed in a middle die interposed between the top die and the bottom die.

22. The imaging system of claim 19, wherein the array of pixels is formed on an image sensor, and wherein the array of pixels is read out using a local readout path to a dedicated set of analog-to-digital converters configured to generate a corresponding accumulated digital signal that is output from the image sensor at the same time as non-digitally accumulated signals that are read out from the image sensor for a given row in the array of pixels.
